(19) United States
(12) Patent Application Publication
(10) Pub. No.: US 2019/0031301 A1
(43) Pub. Date: Jan. 31, 2019

(54) Device For Transforming Kinetic Energy Of Water Flowing In A Horizontal Direction Into Another Kind Of Energy

(71) Applicant: Tocardo Tidal Power B.V., Den Oever (NL)

(72) Inventor: Pieter DE HAAS, Jorwert (NL)

(21) Appl. No.: 16/082,843

(22) PCT Filed: Mar. 7, 2017
(86) PCT No.: PCT/NL2017/050139

§ 371 Date: Sep. 6, 2018

(30) Foreign Application Priority Data
Mar. 7, 2016 (NL) 2016380

(51) Int. Cl. B63B 35/44; H02K 7/18; F03B 13/10

(52) U.S. Cl. CPC B63B 35/44; H02K 7/1823; F03B 13/10; F05B 2250/71; F05B 2210/11; F05B 2220/50; B63B 2035/4466

(57) ABSTRACT

The invention provides a device for transforming kinetic energy of water flowing in a horizontal direction into electric energy, comprising a semi-submerged, frame extending perpendicular to the direction of flow, comprising at least two vertical struts, a number of energy converters connected to said frame, the energy converters comprising a propeller on a propeller shaft in the direction of flow and a generator coupled to the propeller shaft and mooring means, wherein the frame comprises a horizontal connecting structure connecting the vertical struts at their lower ends and having a cross section with a surface area which is equal to or greater than the surface area of the cross section of the vertical struts and wherein the energy converters are connected to the frame by arms between the frame and the energy converters, the cross section of the arms being smaller than the cross section of the frame.

The present invention relates to a device for transforming kinetic energy of water flowing in a horizontal direction into another kind of energy, the device comprising a buoyant semi-submerged at least partially hollow frame of which the main plane extends perpendicular to the direction of flow, the frame comprising at least two substantial vertical struts and a number of energy converting units connected to said frame, each of the energy converting units comprising a propeller mounted on a substantial horizontal propeller shaft extending in the direction of flow and an energy converter of which the rotor is coupled to the propeller shaft.

Such a device is disclosed in GB-A-2 434 410. This device counts four energy converting units only, despite a substantial structural volume.

The aim of the invention is to provide a device of the kind referred to above which can accommodate more energy converters, while maintaining sufficient strength, without impeding the water flow in the vicinity of the energy converters and offering sufficient space for equipment.

This aim is reached by a device of the kind referred to above wherein the frame is substantially U-shaped, wherein each of the energy converting units is connected to the frame by an arm extending between the frame and the energy converting units, each arm connecting a single energy converting unit to the frame, and wherein the cross section of the arms being smaller than the smallest cross section of the frame.

The frame according to the invention provides a sturdy structure, and it allows more energy converters to be accommodated. Further the construction is rather simple, allowing it to be produced with lower costs.

The energy converter may, besides a water turbine, comprise an electric generator to convert the kinetic energy of the flowing water into electrical energy, as is also the case in the prior art document GB-A-2 434 410. However the energy converter may also comprise a hydraulic pump to allow the kinetic energy of the flowing water to be converted into hydraulic energy. Conversion into other kinds of energy, preferably those which are easy transportable, are possible as well.

To provide an optimal stability of the device while floating at the water surface, the frame comprises two vertical struts and two slanting struts, each connecting the lower end of a vertical strut with a ballast tank located at the lowest position of the frame and that the vertical struts comprise widened sections at their upper ends functioning as air chambers. The device is dimensioned to float partially submerged at the water surface.

According to the preferred embodiment each of the lower ends of the vertical struts is joined to a connecting element and that each of the upper ends of each of the slanting struts is joined to a connecting element with a longitudinal shape, that each of the arms connecting the energy converting units to the frame is connected to a connecting element. This embodiment concentrates all forces on the connecting elements, allowing the other parts of the frame to be made lighter. This embodiment further allows a structure wherein one energy converting unit is located between the two substantially vertical struts, which is connected to both connecting elements, thus forming an extra connection between the two connecting elements.

It is further preferred when the centres of the joints between the connecting elements, and the vertical struts, the oblique struts and the arms respectively, are within a first plane parallel to the main plane of the frame. This embodiment minimizes the development of momentums on the connection elements.

Momentums on the other parts of the frame are further reduced when the centres of the energy converting units are all located in a second plane extending in the main plane of the frame. Consequently the stability of the device in the water is enhanced. Herein it is noted that the application of this feature is not limited to the U-shaped frame, but also to devices with frames having other structures.

According to yet another embodiment the vertical struts, the oblique connecting struts and the arms have a cross section with substantially the shape of a lozenge, wherein the longitudinal axis of the lozenge extends perpendicular to the main plane of the device, allowing these parts to be made from plate material, thus reducing production costs, while minimizing the flow resistance. The application of this feature is not limited to the U-shaped frame, but also to devices with frames having other structures.

Concentration of forces on the connection elements is further enhanced when the connecting elements comprise coupling points for connection with anchor lines located at both ends of the connecting elements. Again the application of this feature is not limited to the U-shaped frame, but also to devices with frames having other structures.

Stability of the position of the device in the water against rotation about a horizontal axis is improved when the coupling points for connection with the anchor lines are located on a substantial distance from the plane in which the centres of the energy converting units are located. Again the application of this feature is not limited to the U-shaped frame, but also to devices with frames having other structures.

Another preferred embodiment provides the feature that the shafts of the energy converters extend parallel to the propeller shaft and that the energy converters have a torpedo-shape. This further minimizes the resistance exerted by the device on the water flow and hence the forces on the frame.

Although other materials, such a fibre reinforced plastics and seawater resistant metal alloys are not excluded, it is preferred that the frame is made of steel or an alloy comprising steel.

The ballast is located in the lowermost part of the frame, providing stability against roll and pitch. According to a preferred embodiment the ballast tank is divided in at least two sections by at least one section wall. The ballast tank is used to transfer the device from the vertical position to the horizontal position and vice versa. Transfer from the vertical position to the horizontal position can take place in different directions, that is with the front side up or with the rear side up. The selection of the section which is emptied first, determines the direction of the transfer from the vertical to the horizontal position. The application of this feature is not limited to the U-shaped frame, but also to devices with frames having other structures.

Although it is possible to empty the ballast tank into the water in which the device flows, a preferred embodiment provides the feature that the ballast tank is connectable with the air chambers. This feature forms a closed system, avoiding ingression of sea water, which could lead to pollution of the water system. The application of this feature is not limited to the U-shaped frame, but also to devices with frames having other structures.

To allow access to the interior of the hollow frame, it is preferred that at least one of the parts of the struts emerging above the water surface comprises an closable entrance unit allowing access to the interior of the frame. Positioning the entrance unit above the water level allows access without diving. Preferably the interior of the frame is divided into several sections by section walls, of which some comprise a closable door. The section walls provide a greater stability to the frame, while the sections are useful during possible leaks, by avoiding complete loss of buoyancy. Another preferred embodiment provides the feature that the some of the compartments contain electrical equipment. The electrical equipment which is usually heavy may function as a part of the ballast. It will be clear that in such a case, said part of the ballast is fixed.

The invention also provides a combination of a device of the kind referred to above, wherein and mooring means comprising at least two mooring lines extending at either side of the device with a substantial component perpendicular to the direction of the main plain of the device, the first ends of each of the mooring lines being fixed to coupling points and the second ends of the mooring lines being fixed to anchoring points at mutually opposite sides of the device. This allows a stable positon for both directions of flow.

To increase stability against rotation about a vertical axis, at least some of the mooring lines have a bifurcated structure of which the two ends at the bifurcated side are connected to the frame and the end at the non-bifurcated side is connected to the anchoring point. This embodiment is especially attractive when there are two mooring lines only. This effect would also have obtained by arms extending in the direction of the bifurcated line, but this would be a heavier and more costly solution. It has appeared that stability is optimal when the distance between the bifurcation node and the frame is in the order of magnitude of or larger than the distance between the two connection points between the ends at the bifurcated sides of the mooring lines and the frame.

The device according to the invention must be designed for deployment in rough circumstances, such as high waves, high wind and strong currents. To allow the mooring lines to absorb at least a part of such forces, it is preferred that the mooring lines each comprise a first section between the device and a buoy and a second section between the buoy and the anchoring point, wherein the second section comprises a subsection adjacent to the anchoring point, having a specific weight per length which is at least a factor 10 greater than that of the first section. Herein the weight of the subsection functions as a damper or spring for the forces in the mooring lines. However it is also possible to provide the subsection of the second section of the mooring lines with a single concentrated or lumped weight, which will have a similar effect. It is also possible to use a multitude of such lumped weights. However the distributed weight of the heavy line allows an easier installation or removal.

In a practical embodiment the subsections of the mooring lines are formed by a chain.

Preferably a power cable is guided along one of the mooring lines and that the power cable is attached to the mooring lines at regular distances. This feature allows a proper guiding of the power cable which avoids high fatigue bending loads on the cable due to hydrodynamic loads from waves and current. The power cable is thus more constrained.

The present invention also provides a method for transferring a device of the kind referred to above from a substantial vertical position into a substantial horizontal position, wherein water is transferred from the ballast tank to at least one of the air chambers. The invention also provides a method for transferring the same device from a substantial horizontal position into a substantial vertical position, by transferring water from at least one of the air chambers to the ballast tank. Further it is preferred that the water is kept within the closed circuit comprising the ballast tank and air chambers to avoid ingression of outside water.

Preferably the combination of the kind referred to above is installed by the steps of—launching the device into the water, wherein the frame extends substantially horizontally, transporting the device to the its installation location, entering water into the ballast tank, thus changing the position of the frames from substantially horizontal to substantially vertical and mooring the frame by mooring lines.

Finally it is preferred when the transfer of water from the ballast tank to the air chambers or vice versa takes place by urging air into the ballast tank and releasing air from the air chambers or by urging air into the air chambers and releasing air from the ballast tank respectively.

Subsequently the present invention will be elucidated with the help of the accompanying drawings, showing;

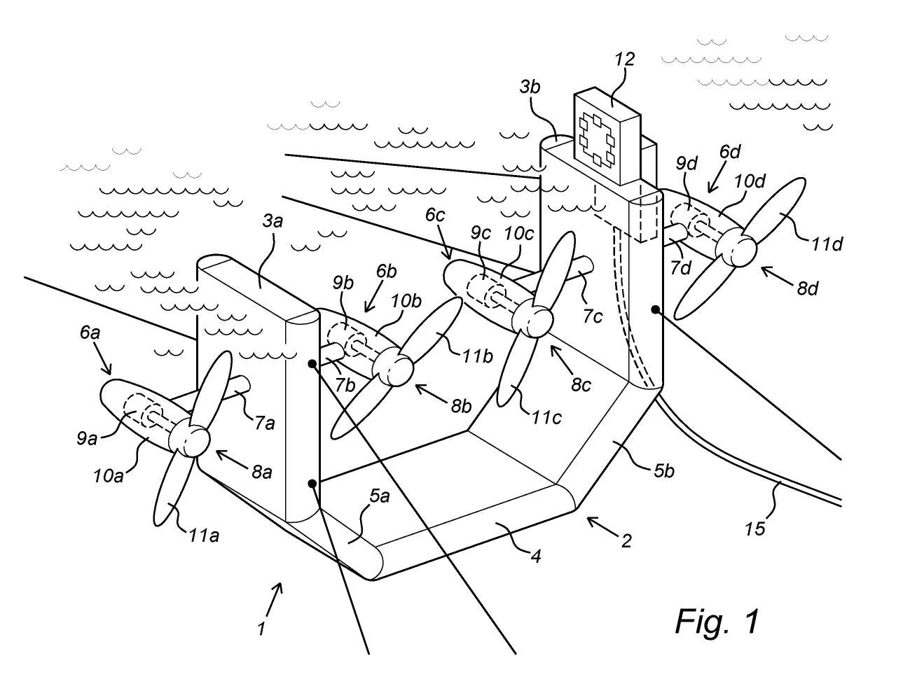

FIG. 1: a perspective view of a first embodiment of the invention;

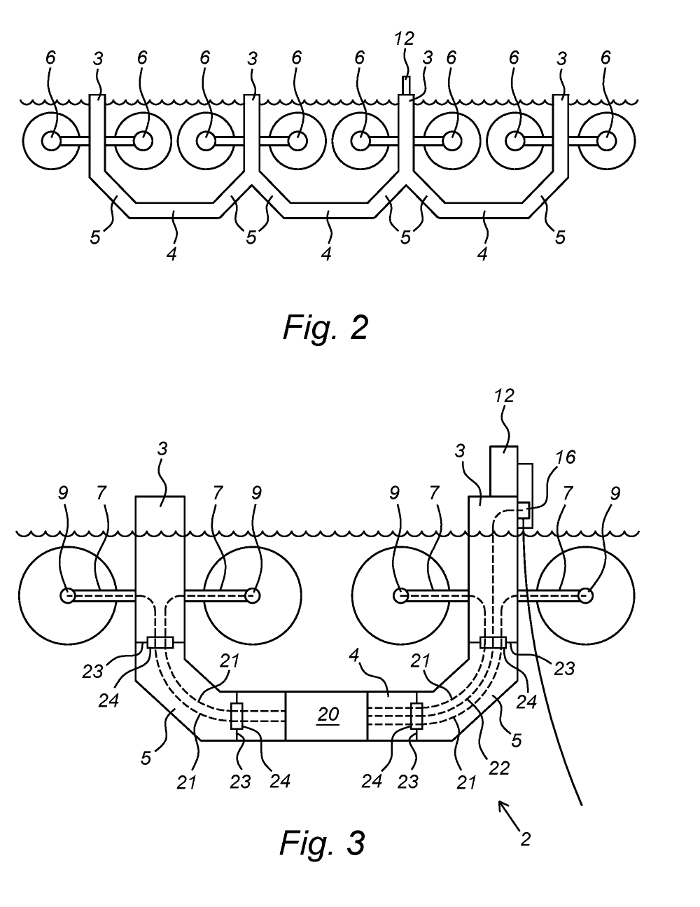

FIG. 2: a cross-sectional diagrammatic view of a second embodiment;

FIG. 3: a cross-sectional diagrammatic view of the first embodiment;

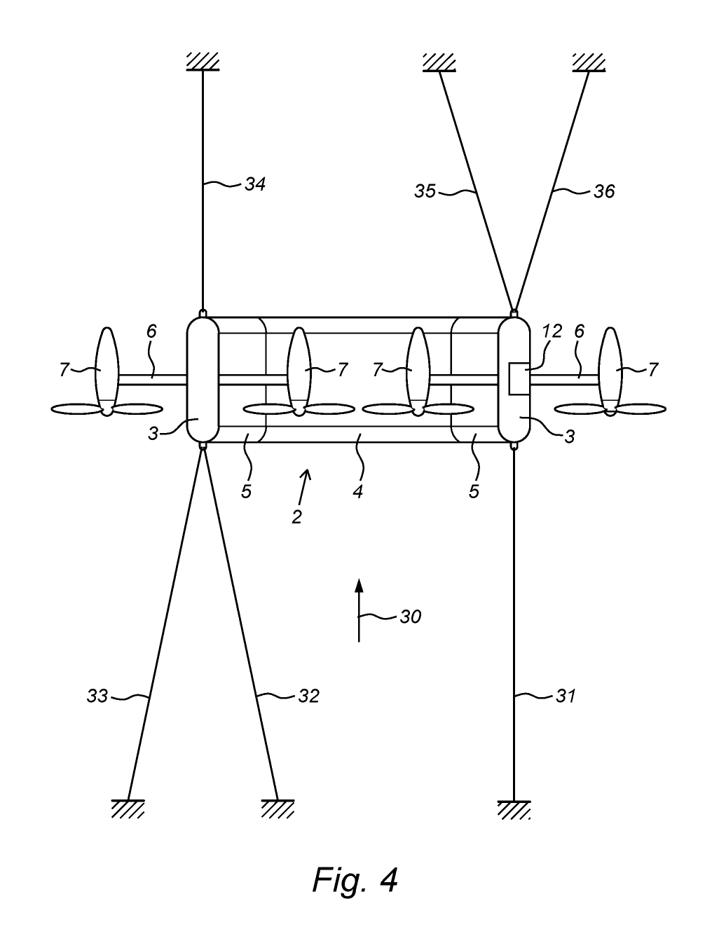

FIG. 4: a top view of the first embodiment, including mooring lines;

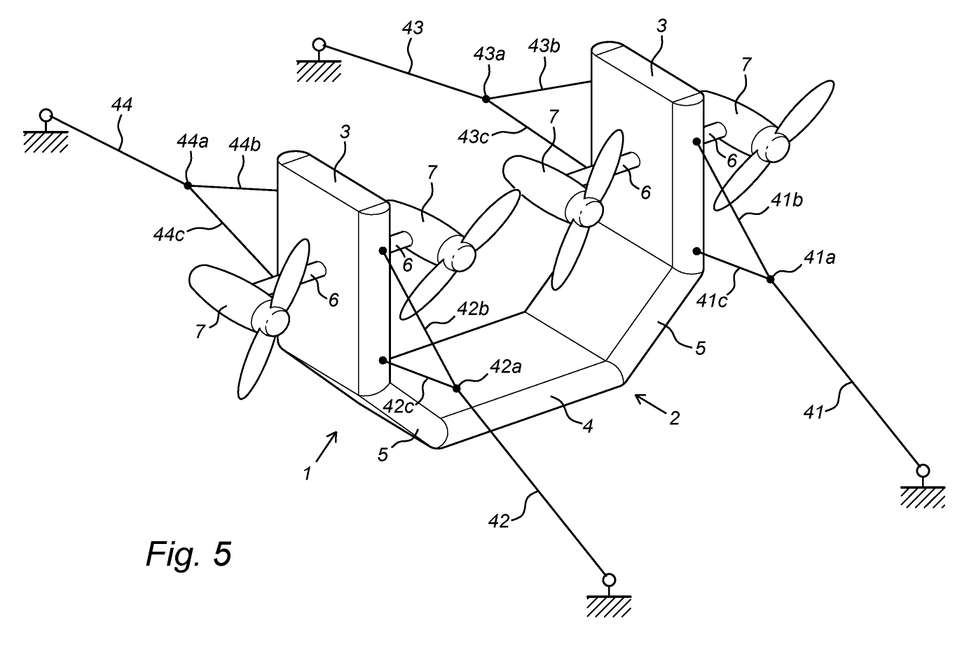

FIG. 5: a perspective view of a third embodiment;

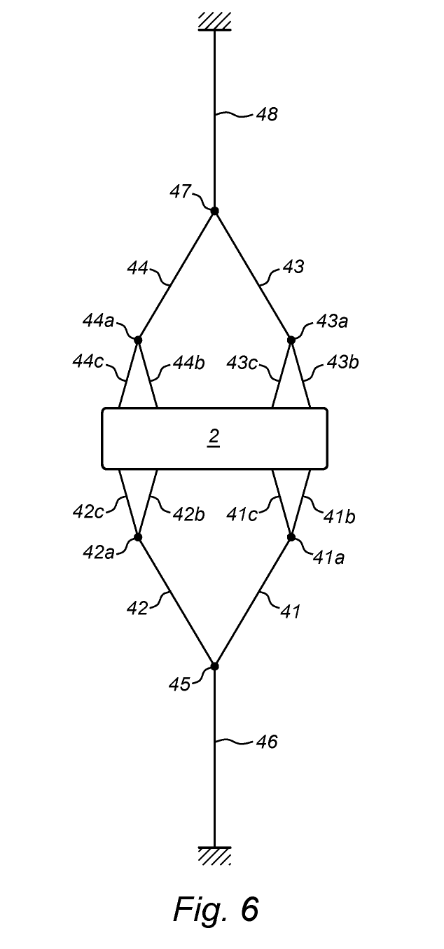

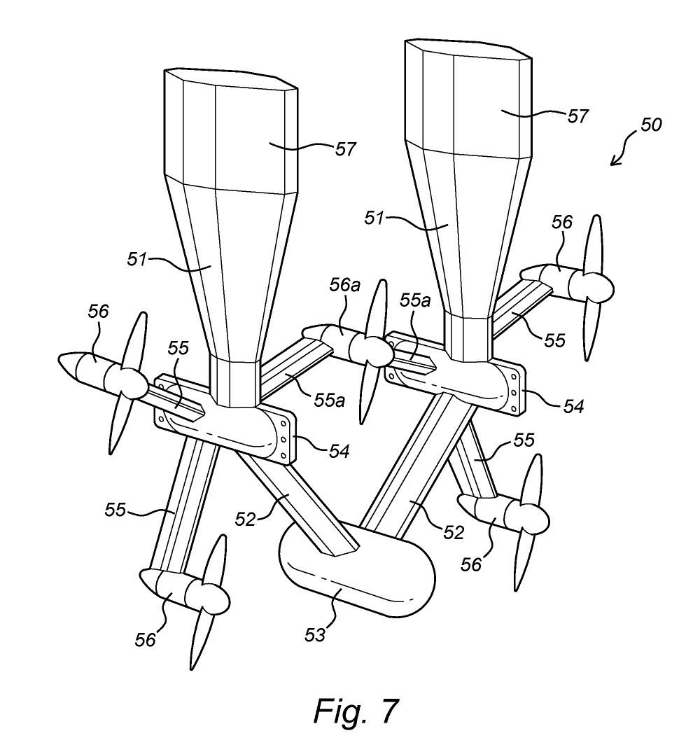

FIG. 6: a diagrammatic plan view of a fourth embodiment;

FIG. 7: a perspective view of a fifth embodiment;

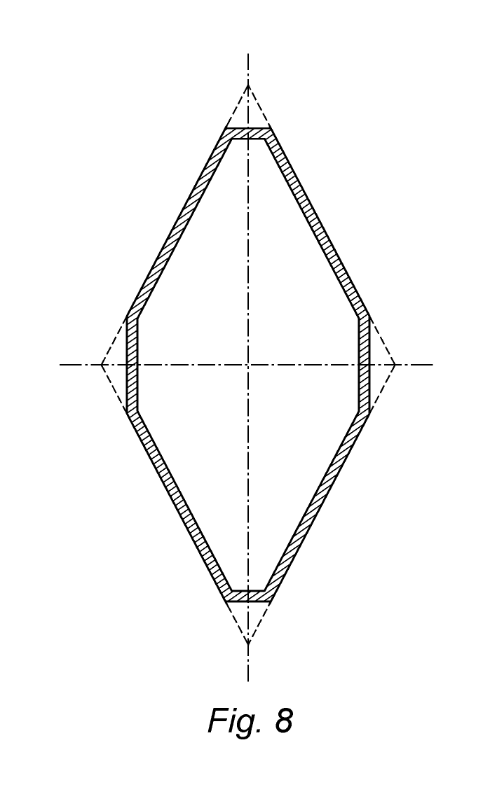

FIG. 8: a cross sectional view of the fifth embodiment;

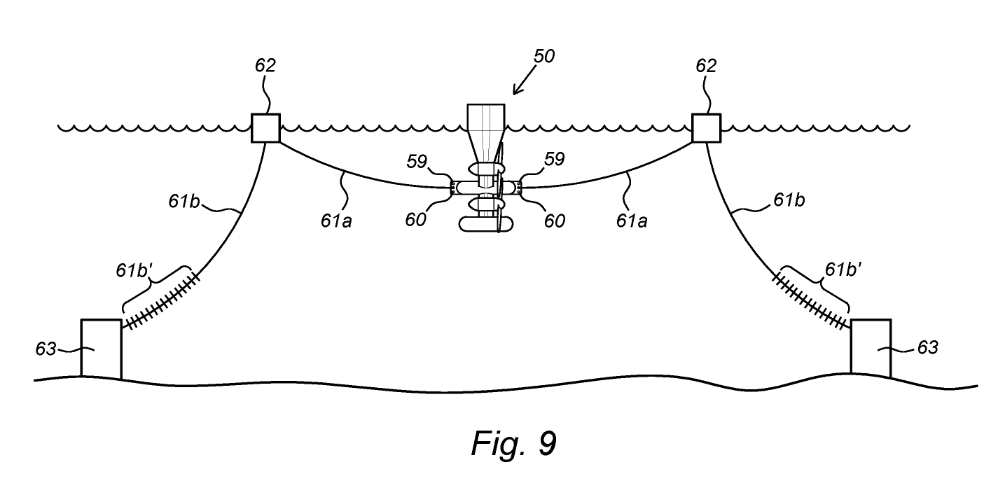

FIG. 9: a vertical cross sectional view of the combination of the fifth embodiment with mooring means;

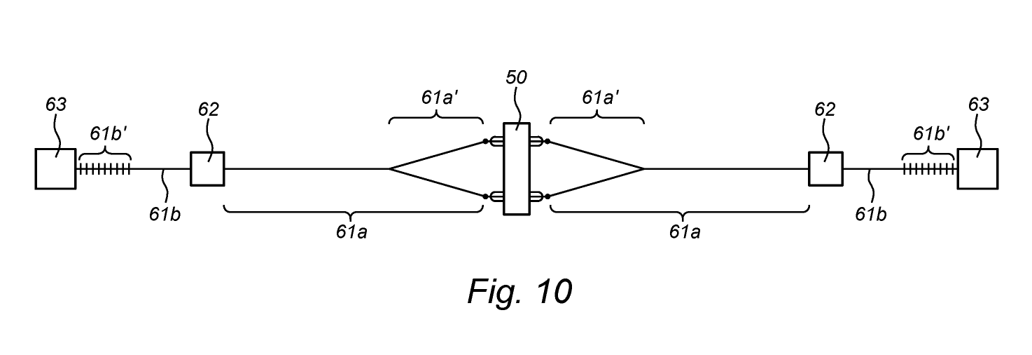

FIG. 10: a top view of the combination depicted in FIG. 9; and

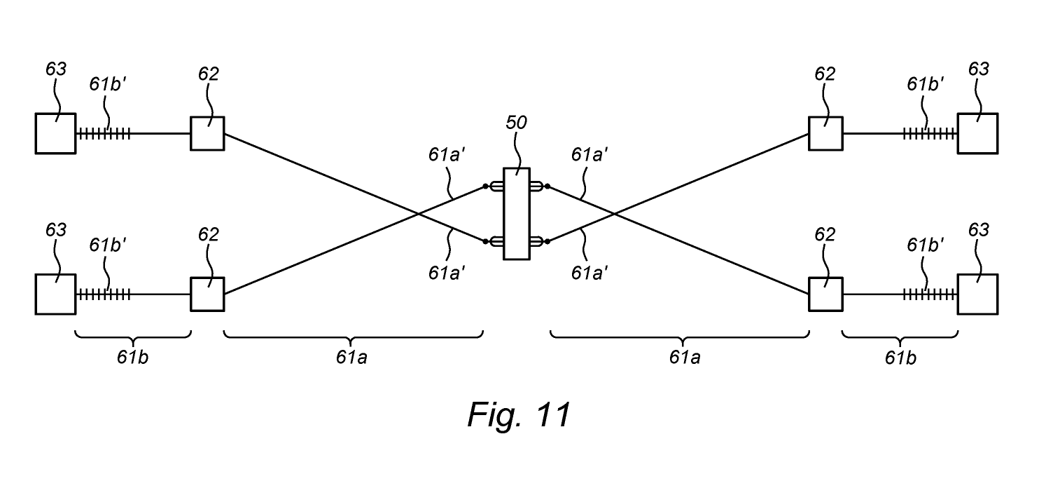

FIG. 11: a top view of a variant of the combination depicted in FIG. 10.

FIG. 1 depicts a device according to the invention, which device is designated as a whole by the number 1. The device is located semi buoyant in a water such as the sea, an estuary or a chamber of a lock, in particular in a water in which a strong current is prevalent. The device comprises a hollow frame 2, which is preferably made of steel. The hollow frame 2 comprises two hollow vertical struts 3a, 3b respectively, an horizontal part 4 and two slanting connecting parts 5a, 5b respectively. Al these parts together form the generally U-shaped frame 1 All these parts have side walls extending in the direction parallel to the water flow. The wall of these parts extending perpendicular to the direction of the water flow have a semi-circular convex shape to minimise resistance for the flowing water.

Further the device comprise four energy converters 7a, 7b, 7c, 7d respectively, each of which is connected to one of the struts 3a, 3b through an arm 6a, 6b, 6c, 6d respectively. It is noted that two energy converters 7 are connected to each of the struts 3, such that the struts 3 enclose two energy converters 7b and 7c and the two remaining energy converters 7a, 7d respectively, are located at the outer sides of the struts 3. Preferably the arms are made steel, just as the frame 2, although other materials are not excluded.

Each of the energy converters 7 comprises a water turbine 8 and a generator 9, combined into a nacelle 10. The water turbine 8 further comprises blades 11, connected to its shaft. Preferably but not necessarily, the shaft of the water turbine 8 is directly connected to the shaft of the generator 9. However, it is also possible that a non-depicted gear box is located between the water turbine 8 and the generator 9. Further the shaft of each of the water turbines 8 extends parallel to the direction of flow of the water. To make the cross section of the nacelle 10 perpendicular to the direction of flow as small as possible, it is preferable that the shaft of the generator 9 extends parallel to the shaft of the water turbine 8. There may be design considerations leading to the shaft of the generator 8 extending in another direction.

The dimensions and the weight of the frame 2 and the energy converters 7 and auxiliary equipment, are such that the device floats in the water with the frame 2 semi submerged. On top of the part of the strut 3b above the water surface, an entrance unit 12 has been provided, allowing access to the inner parts of the hollow frame. The entrance unit 12 is a box shaped part having a door 1. However it may also be formed by a hatch as in a submarine. Other forms of entrance unit, such as that common in submarines are not excluded. To transfer the electrical energy generated in the energy converters to the electrical distribution grid, a cable 15 has been provided. The end of the cable not visible in the drawing is connected to such a grid, possibly via a switching station, while the visible end of the cable 15 is guided to a connection box 16 attached to the frame above the water surface and—in this embodiment—adjacent to the entrance unit. However other locations of connection box, such as below the water surface are not excluded. The connection box itself is connected to the energy converters, as will be later described in conjunction with FIG. 3.

The embodiment depicted in FIG. 2 discloses an alternative embodiment having the structure of a three U's taken together, comprising four struts 3, three horizontal parts 4 and six slanting parts 5. It is possible to replace the three horizontal parts 4 with a single horizontal part having a greater length and to connect the middle two struts directly to the horizontal parts, thus avoid the four middle slanting parts 5. This embodiment is attractive in situation wherein less extreme weather is to be expected, as the frame has a greater length, and is hence more vulnerable for forces, but offers locations for eight energy converters rather than four.

The cross sectional view of FIG. 3 shows the embodiment of FIG. 1, more in particular the electrical connections of the device. In the horizontal part 4 an electrical unit 20 has been provided, which is adapted to convert and stabilise the voltage and current generated by the generators 9 to a voltage and current which are suitable for transfer through the cable 15. In most cases the generators will be adapted to generated the 3-phase AC, of varying voltage and frequency, dependent from the rotational speed of the rotors of the water turbines and the generators. The electrical unit converts this varying voltage and frequency to DC with a stable voltage or AC with a stable voltage and frequency. Further, assuming that the generators are synchronic generators, the electrical unit controls the excitation of these generators. Finally the electrical unit comprises safety devices such as switches allowing to switch off a generator or the cable when faults appear.

The electrical unit is connected to the generators by cables 21 and to the connection box 16 by a cable 22. The frame is divided into compartments with are separated by bulkheads 23, which have been provided with cable glands 24 for the cables 21, 22. Further the bulkheads comprise doors not depicted in the drawings for access to the compartments for maintenance and repair.

FIG. 4 shows an elevational view of the device, disclosing the mooring lines. In this embodiment it is assumed that the device is fixed in the vertical direction by its buoyancy. For fixation in the horizontal plane mooring lines extending with a substantial horizontal component are required. Further, as expressed in the claims, the ends of the mooring cables should be attached to the frame in in the most lateral positions to avoid rotation of the frame around the vertical axis. In FIG. 4 the direction of flow is indicated by the arrow 30. The device comprises six mooring lines 31, 32, 33, 34, 35 and 36 of which three; 31, 32 and 33 extend in the direction upstream direction. One end of mooring line 31 is attached to the right hand strut 3b, on a height substantially of the arms 6, that is the height in which the forces exerted by the water flow can be concentrated. Further ends of mooring lines 32, 33 are both attached to the left hand strut 3a, on different heights; the end of line 32 above the height of the attachment of the line 31 and the end of mooring line 33 below that height. These different heights are required to stabilise the frame against rotation around its horizontal axis perpendicular to the direction of flow. The different angles under which the two mooring lines 32, 33 extend, provide stability against lateral movement of the frame. The mooring lines 31, 32 and 33 are loaded when the water flows in the direction indicated by the arrow 30, and the mooring lines 34, 5 and 36 are loaded when the water flows in the other direction.

For the situation when the direction of flow is reversed, such as in tidal waters, the end of mooring line 34 is attached to the left hand strut 3a, and ends of the mooring lines 35 and 36 are attached to the right hand strut 3b. Hence a mirrored configuration appears. Variations on this mirrored configuration are possible. Hence two mooring lines extending downstream may be attached to the left hand strut 3a and a single mooring line may be attached to the right hand strut 3b, while further different numbers of mooring lines may be attached to the frame.

The mooring lines 31-36 may be formed by steel lines, lines made of fibres or by chains. The other ends of the mooring lines 31-36 are attached to anchoring points, for instance on anchors on the sea bed, on the shores or banks of the sea, lakes or rivers or on engineering structures.

FIG. 5 depicts an embodiment of which only the mooring lines differ from those of the embodiments of FIG. 1. This embodiment comprises four mooring lines 41-44, which are all bifurcated. These lines 41-44 all comprise a bifurcation node 41a-44a, from which two lines 41b-44b, respectively 41c-44c extend to the frame 2, in particular to the vertical struts 3 thereof. Connection points between the lines 41b, 41c respectively and the struts 3 are on different heights, with the level of the connection points between the arms and the struts 3 therein between. This is also the case for the other bifurcated lines 42, 43 and 44. This drawing discloses that the mooring lines 41, 42 are connected to a single anchoring point at one side of the device and the mooring lines 43, 44 are connected to a single anchoring point at the other side of the device.

It is however also possible that the mooring lines at either side of the device are connected to a single united mooring line, through a further bifurcation, as disclosed in FIG. 6. This embodiment is generally in accordance with the embodiment depicted in FIG. 5, but the lines 41, 42 are not connected to a single anchoring point, but, at a bifurcation 45 rather to another mooring line 46, which is connected to an anchoring point. The mooring lines 43, 44 are, at a bifurcation 47, correspondingly connected to a single mooring line 48, which as connected a single anchoring point.

The embodiment depicted in FIG. 7 also comprises a U-shaped frame 50, comprising vertical struts 51, two slanting struts 52, wherein the slanting struts 52 are mutually connected at their lower ends by a ballast tank 53. Each vertical strut is connected at its lower end to a connecting element 54 and both slanting struts 52 are at their uppers ends connected to a connecting element 54, Thus forming the U-shaped frame 50. To each of the connecting elements 54 two arms 55 extending in the outward direction are provided and to the distal end of each of said arms 55 an energy conversion unit 56 is provided. Further an arm 55a extending in the inward direction is provided at bot connecting elements 54 and a single energy conversion unit 56a is provided, connected with each of these arms 55a. The upper sections of the vertical struts 51 are widened to form air chambers 57. Each of the energy conversion units 56 are formed by a combination of a water turbine and an electric generator.

The cross section of each of the struts 51, 52 and the arms 55 has the shape of a lozenge, as is depicted in FIG. 8 which shows a cross section of a vertical strut 51. This shape allows a simple production from plate material, and it has a low flow resistance. The edges of said components are chamfered by strips, avoiding sharp welding seams. It is clear that the cross section of arms 55 is smaller than that of the struts 51, 52.

This configuration allows to adapt the size of the frame 50, to the diameters of the rotors of the water turbines by simply varying the lengths of the struts 51, 52 and the arms 55, thus simplifying the design procedure for different powers. Further the ballast tank 53 is divided into two or more compartments and all of these compartments are connectable to the air chambers 58 forming the upper sections of the vertical struts 51, to allow water to be transferred between these vessels 53, 58. Both vessels 53, 58 have connections to allow the vessels to be connected to an air pump transferring the water between the ballast tank 53 and the air chambers 58.

The connection elements 54 are formed by torpedo shaped members, and the centres of all struts 51, 52 and arms 55 connected thereto reside in the same plane, thus reducing momentums in the frame 50. Further the connection elements 54 are centrally provided with coupling plates 59 in which holes 60 are made to allow coupling to the mooring lines. The coupling plates extend a substantial distance on both sides from the centre plane of the frame 50. In both ends of the coupling plates three holes 60 are provided to allow adjustment of the position of the frame. Electrical equipment, such as control units, switches and transformers, is located in the vertical struts.

FIGS. 9 and 10 show the configuration of the mooring lines for the fifth embodiment. The vertical cross sectional view of FIG. 9 discloses the frame 50 and the parts connected thereto, including the coupling plates 59 of the connection elements to which mooring lines 61 are connected via the holes 60. Both mooring lines 61 comprise a first section 61a extending between the coupling plates 59 and buoys 62 floating partially at or completely submerged below the water surface, which sections are made of nylon and second sections 61b extending between the buoy 62 and the anchors 63 on the bottom. These second sections 61b are also formed by nylon, although they comprise subsections 61b′ adjacent to the anchors 63 which subsections 61b′ are formed by chains. These chains 61b′ allow to absorb forces urged by the frame 50 by the weight of the chains 61b′. In this embodiment the single weight is distributed over the length of the chain, but it is also possible to use a single or a multitude of concentrated or lumped weights.

The bifurcated structure of the mooring lines appears from FIG. 10 displaying a top view of the combination of device and mooring lines depicted in FIG. 9. The first sections 61a of the mooring lines both comprise a bifurcated section 61a′, which serves to stabilize the frame 50 against rotation about a vertical axis.

The preceding combination, comprises two mooring lines only, but the combination depicted in FIG. 11 comprises four mooring lines, two at either side of the device.

Although the invention has been elucidated with the help embodiments according to the preceding description and drawings, the features of the several embodiments may be combined as the skilled would do, and the scope of the invention is determined by the claims.

1. Device for transforming kinetic energy of water flowing in a horizontal direction into another kind of energy, the device comprising:
a buoyant semi-submerged, at least partially hollow frame of which the main plane extends perpendicular to the direction of flow, the frame comprising at least two substantially vertical struts; and
a number of energy converting units connected to said frame, each of the energy converting units comprising a propeller mounted on a substantial horizontal propeller shaft extending in the direction of flow and an energy converter of which the rotor is coupled to the propeller shaft,
characterized in
that the frame is substantially U-shaped,
that each of the energy converting units is connected to the frame by an arm extending between the frame and the energy converting units,
that each arm connects a single energy converting unit to the frame, and
that the cross section of the arms is smaller than the smallest cross section of the frame.

2. Device as claimed in claim 1, characterized in that the frame comprises two vertical struts and two slanting struts, each connecting the lower end of a vertical strut with a ballast tank located at the lowest position of the frame and that the vertical struts comprise widened sections at their upper ends functioning as air chambers.

3. Device as claimed in claim 1 or 2, characterized in that each of the lower ends of the vertical struts is joined to a connecting element and that each of the upper ends of each of the slanting struts is joined to a connecting element with a longitudinal shape, that each of the arms connecting the energy converting units to the frame is connected to a connecting element.

4. Device as claimed in claim 3, characterized in that the centres of the joints between the connecting elements, and the vertical struts, the oblique struts and the arms respectively, are within a first plane parallel to the main plane of the frame.

5. Device as claimed in any of the preceding claims, characterized in that the centres of the energy converting units are all located in a second plane extending in the main plane of the frame.

6. Device as claimed in any of the preceding claims, characterized in that the vertical struts, the oblique connecting struts and the arms have a cross section with substantially the shape of a lozenge, wherein the longitudinal axis of the lozenge extends perpendicular to the main plane of the device.

7. Device as claimed in any of the preceding claims, characterized in that the connecting elements comprises coupling points for connection with anchor lines located at both ends of the connecting elements.

8. Device as claimed in claim 7, characterized in that the coupling points for connection with the anchor lines are located on a substantial distance from the plane in which the centres of the energy converting units are located.

9. Device as claimed in any of the claims 2-8, characterized in that the ballast tank is divided in at least two sections by at least one section wall.

10. Device as claimed in any of the claims 2-9, characterized in that the ballast tank is connectable with the air chambers.

11. Combination of a device as claimed in claim 7 or 8, and mooring means, characterized in that the mooring means comprises at least two mooring lines extending at either side of the device with a substantial component perpendicular to the direction of the main plain of the device, the first ends of each of the mooring lines being fixed to coupling points and the second ends of the mooring lines being fixed to anchoring points at mutually opposite sides of the device.

12. Combination as claimed in claim 11, characterized in that the first ends of the mooring lines have a bifurcated structure and that the bifurcated ends are connected to the connection points of the device and the second ends are connected to the anchoring points.

13. Combination as claimed in claim 11 or 12, characterized in that the mooring lines each comprise a first section between the device and a buoy and a second section between the buoy and the anchoring point, wherein the second section has a specific weight per length which is at least a factor 10 greater than that of the first section.

14. Combination as claimed in claim 13, characterized in that the second section of the mooring lines comprises a sub section adjacent to the anchoring point formed by a chain.

15. Combination as claimed in any of the claims 11-14, characterized in that a power cable is guided along one of the mooring lines and that the power cable is attached to the mooring lines at regular distances.

16. Method for transferring a device as claimed in any of the claims 1-10 from a substantial vertical position into a substantial horizontal position, characterized by transferring water from the ballast tank to at least one of the air chambers.

17. Method for transferring a device as claimed in any of the claims 1-10 from a substantial horizontal position into a substantial vertical position, characterized by transferring water from at least one of the air chambers to the ballast tank.

18. Method for installing a combination as claimed in any of the claims 11-15, characterized by the followings steps:
launching the device into the water, wherein the frame extends substantially horizontally;
transporting the device to the its installation location;
filling water into the ballast tank, thus changing the position of the frames from substantially horizontal to substantially vertical; and
mooring the frame by mooring lines.

19. Method as claimed in any of the claims 16-18, characterized in that the transfer of water from the ballast tank to the air chambers or vice versa takes place by urging air into the ballast tank and releasing air from the air chambers or by urging air into the air chambers and releasing air from the ballast tank respectively.
